(19) United States
(12) Patent Application Publication
(10) Pub. No.: US 2004/0138914 A1
(43) Pub. Date: Jul. 15, 2004

(54) Operation processing method, program and device therefor

(76) Inventors: Takayuki Toyama, Kawasaki-shi (JP); Isao Higashihara, Tokyo (JP)

Correspondence Address: PILLSBURY WINTHROP, LLP, P.O. BOX 10500, MCLEAN, VA, 22102, US

(21) Appl. No.: 10/705,244

(22) Filed: Nov. 12, 2003

(30) Foreign Application Priority Data
Nov. 11, 2002 (JP) 2002-326650

(51) Int. Cl. G06F 17/60

(52) U.S. Cl. 705/1; 705/7

(57) ABSTRACT

The present invention treats a three sectional housing as one processing unit. This three sectional housing is structured by comprising a first section in which each kind of group of input elements for the phenomena to be made into a model is arrayed as a tenant in one line or one column, a second section in which an output elements group having a causal relationship with each individual tenant arranged in the first section is arrayed as a tenant in 1 column or 1 line and a third section in which logic revealing the respective relationships of each tenant arrayed in the first section and each tenant arrayed in the second section is arrayed as a tenant on a grid, such that, where a tenant exists that is common to both the first section and the second section, an output elements group obtained by a tenant of the second section is taken as an input elements group of a tenant that is common with the first section, and lower rank housings can be nested hierarchically to provide tenants for each section of the three sectional housing. In this invention, processes are classified according to the section of the upper rank sectional housing a nested housing exists in, and the processes of a nested housing operation are themselves closed by that operation.

### BACKGROUND OF THE INVENTION

1. Field of the Invention

This invention relates to technology for showing cause and effect relationships of management phenomena, socioeconomic phenomena or natural phenomena. More specifically, this invention relates to information processing technology for assessing and devising plans for business management, for calculating performance in the field of business management and for planning and assessment in socioeconomic fields. More specifically still, this invention relates to technology for using information processing equipment for multi-layered presentation of complex phenomena expressed as large chains of operation logic, bringing greater overall visibility and making the phenomena easier to understand, and for performing calculations that are based on descriptors that are efficient and perform well by penetrating to the details of each phenomenon.

2. Description of Related Art

When showing causal relationships of management phenomena, socioeconomic phenomena or natural phenomena in a model, it is preferable that data forming the frameworks and the operation logic therefor be expressed with a high degree of overall visibility that provides transparency. The applicants of the present invention filed a patent application claiming an invention providing such technology, disclosing a unique structure that provides a clear view at each processing step, that is to say the “three sectional housing” (see JP2001-357190, A, hereinafter referred as a “prior application”). he three sectional housing brings a grid structure comprised of the 3 sections of the upper section, midsection and left section, where information exists as a tenant in each individual grid (known as each “room”) and provides a structure that maintains a framework enabling an operation to specify a tenant of the midsection and apply vertical and horizontal relationships between information of the 3 sections (refer to FIG. 1).

This structure enables a view overall of operational relationships, using rooming tables of the three sections holding management information and arrangement related information concerning information housed in the rooms (refer to FIG. 3) and allows a user to access information of a tenant by clicking on the tenant in a rooming table of the 3 sections. The name of a common tenant can be registered in the upper section and left section rooms and that tenant information can be shared. Such a tenant will be called as an “intermediate tenant”. Starting from a tenant that is present in the upper section but not present in the left section, such a tenant will be called as a “pre-determination tenant”, information of a tenant within the room of the midsection directly thereunder, such a tenant will be called as a “midsection tenant”, is calculated. The results for each room in columns parallel obtained by the same operation are then calculated along the horizontal direction, those results forming information of a tenant within the left section room directly to the left, such a tenant will be called as a “left section tenant”. When a common tenant name is registered in an upper section and left section room, then, again taking the upper section tenant as the starting point, the same operation is performed in progression to obtain, successively, the results calculated for the left section tenant and these processes are continued until all operations to read out from the rooming table are completed.

The operation performed can be of a wide range, including arithmetic calculations, matrix operations, renormalization series calculations, conditional calculations, list data processing and the like, while a loop operation of conditions for all housing are also possible. The processes of simply passing or selecting information are also included. Further more, it is possible to run executable to run objects including macroinstructions and system commands etc. In the description of the present invention herein, the term “operation” includes all such processes.

Tenants bearing a type symbol that applies characteristics or properties to an operation used are arranged in the midsection. An operation spanning the upper section and the left section are performed through the interpretation of these tenants, this rendering conventional programming largely unnecessary.

Further, besides these tenants including numeric values data, script data and binary data, a nested housing is also possible. Thus, construction, alteration and execution of an operation of a model integrated with a nested housing can be realized by arranging the 3 sections of the midsection, left section and upper section of the rooming table in upper rank housing.

In nesting a three sectional housing of the lower rank in a three sectional housing of the upper rank, the nested three sectional housing of the lower rank is broken down and handled over three sections in the rooming table of the upper rank three sectional housing (see FIG. 5). That is to say, there is a cross over type registration in which information of the left section of the nested three sectional housing is registered in the upper section of the upper rank housing and information of the upper section of the nested three sectional housing is registered in rooms of the left section, enabling a three sectional housing chain over the upper and lower ranks. This can be arranged in layers, enabling unfolding to the lower rank three sectional housing from the rooming table displayed on screen. Further, enabling these computations as part of upper rank three sectional housing operation enables construction of a larger model structure. A link table enabling passing information with the nested three sectional housings is arranged in the midsection of the upper rank three sectional housing and detailed deliveries are performed.

For arranging a nested three sectional housing structure in an upper rank three sectional housing and passing through the nested housing during the operation of the upper rank housing, areas for an intermediate tenant are held in the rooming table of the upper rank three sectional housing, a character string (e.g. “U”) for recognizing the upper section is added to the nested three sectional housing name on the left section of the rooming table of the upper rank three sectional housing for receiving input from the upper rank three sectional housing, same character string (added “U”) is arranged in the upper section of the upper rank three sectional housing for receiving data from the left section of the rooming table, a nested three sectional housing name meaning the midsection of the nested three sectional housing is arranged directly under the midsection part of the rooming table, the nested three sectional housing name and a character string recognizing the left section (e.g. “L”) added are arranged in the left section, and same character string is arranged in the upper section for receiving data from the left section. By such arrangement, information can be passed between the upper rank three sectional housing and the nested three sectional housing and an operation from the upper rank three sectional housing are performed.

According to the conventional operation method, there are five places for registration in a rooming table of an upper rank three rank housing when a three sectional housing should be nested in the upper and left sections of the upper rank three sectional housing, and four places when a three sectional housing should be nested in only the upper section or the left section of the upper rank three sectional housing. The sections must be handled as separate designations, moreover, in the upper section of the upper rank rooming table arrangement to enable recognition of the left section name of the nested three sectional housing —arrangement that contradicts the natural inclination of the user—is unavoidable, leading to frequent occurrence of operating errors, creating significant problems affecting the efficiency of registration operations and the efficiency of planning operations. urther, as the number of places for registration in the rooming table of the upper rank three sectional housing increases, the rooming table itself expands such that a section displayed on screen comes to occupy a large region vertically and horizontally, leading to inefficient operations in displaying the table and reaching the necessary location for display, making it difficult to get an overall grasp of how a model operates.

Moreover, as the nested three sectional housing is divided in different sections and registered, due to structural expression restrictions substantial registration input prohibited areas arise in the rooming table, there are problems in the efficiency of operating on screen, such as deterioration in the effectiveness of the display on screen or an increased frequency of the need to scroll in the table or the like, and meaningless zones occur that invite the possibility of confusing a user, inhibiting them from gaining a direct, almost intuitive understanding of the model displayed.

For passing data of an upper section tenant of the nested three sectional housing to a tenant (including a nested housing) other than of that nested three sectional housing, it is necessary to pass that data to the upper section tenant of the required midsection tenant after the operation of the nested three sectional housing is executed and data for a left section tenant of the upper rank housing is obtained. From a modeling perspective, this requires a complex operation inhibiting operations efficiency.

In view of the current state of the conventional technology there are practical limitations on the view available to the user, on the breadth of display, ease-of-use and conceivability. Accordingly, the subject area of a model requiring expression is extremely large and the relationships between different elements handled are complex and diverse. Computer technology that facilitates easy handling is therefore required. Additional requirements are for

1. Execution of the operation of a model expressed, moreover, the enabling of successively detailed focus, as is available from an atlas, moving successively from a macro expression of the model towards a micro expression of the model focusing on a specified part expressed in the macro view thereby facilitating understanding of both the whole and the parts of the model and

2. Illustration of all obtainable, mutually interactive cause and effect elements of a model, because the overall image must be, in the final analysis, one expansive all-encompassing view.

In the method disclosed in the prior application, however, in order to register a nested housing in a rooming table, due to the requirement for setting information delivery with the upper rank housing, the nested housing also must be unfolded inside the upper rank rooming table. This does not always result in a simple structure, so the registration operation itself is not simple.

### SUMMARY OF THE INVENTION

The object of the present invention is to solve these problems by providing an operation processing method having a simple multi-layered arrangement of housings, and that operates with simple structures, facilitating easy to understand registration operations, enabling registrations to be performed simply.

The specific features of the present invention are that processes are classified according to the section of the upper rank sectional housing a nested housing exists in, and the processes of a nested housing operation are themselves closed by that operation.

According to a first aspect of the present invention, it is provided an operation processing method for treating a three sectional housing as one processing unit, wherein;

the three sectional housing is structured by comprising a first section in which each kind of group of input elements for the phenomena to be made into a model is arrayed as a tenant in one line or one column, a second section in which an output elements group having a causal relationship with each individual tenant arranged in the first section is arrayed as a tenant in 1 column or 1 line and a third section in which logic revealing the respective relationships of each tenant arrayed in the first section and each tenant arrayed in the second section is arrayed as a tenant on a grid, such that, where a tenant exists that is common to both the first section and the second section, an output elements group obtained by a tenant of the second section is taken as an input elements group of a tenant that is common with the first section, and lower rank housings can be nested hierarchically to provide tenants for each section of the three sectional housing;

when there is a lower rank housing forming tenants in the first section and the second section of an upper rank three sectional housing commonly (such a lower rank housing referred to as an “intermediate housing” meaning a housing of an operation performed during an operation for the upper rank housing), in accordance with the operation sequence of the upper rank three sectional housing information is passed to the lower rank housing being the tenant of that second section, and the operation of that upper rank three sectional housing continues using the result of the operation of the lower rank housing as information of the concerning tenant of the first section of the upper rank three sectional housing;

when there is a lower rank housing forming a tenant only in the first section of the upper rank three sectional housing (such a lower rank housing referred to as a “pre-determination housing” meaning performance of an operation preceding an operation for the upper rank housing), prior to commencement of an operation for the concerning tenant for that upper rank three sectional housing, a lower rank housing operation is performed and using the results of that lower rank housing operation as the information on the concerning tenant of the upper rank three sectional housing, the operation for that upper rank three sectional housing continues;

and when there is a lower rank housing forming a tenant only in the second section of the upper rank three sectional housing (such a lower rank housing referred to as a “post-determination housing” meaning an operation of the results of the upper rank housing operation) in accordance with the operation sequence of the upper rank three sectional housing information is passed to the lower rank housing forming the tenant of that second section, and the result of the operation performed of that lower rank housing is taken as information of the concerning tenant of the upper rank three sectional housing. In this specification, “operation” includes not only arithmetic calculations, matrix operations, renormalization series calculations, conditional calculations, list data processing and the like, but also the processes of simply passing and receiving information. The lower rank housing may be itself one three sectional housing, information from the upper rank three sectional housing is taken as information of the first section, and information obtained in the second section can be passed to upper rank three sectional housing.

The lower rank housing may also be a single sectional housing for which input and output element groups are arranged respectively as tenants in one line or one column but where these themselves do not require execution of any operation can also be used.

In this case, a different single sectional housing or three sectional housing can be nested as a tenant in single sectional housing.

A lower rank housing can be nested as a tenant of the third section of the upper rank three sectional housing. A table (called a “link table”) for passing information between a tenant corresponding to the first section of that upper rank three sectional housing and a tenant corresponding to the second section of that upper rank three sectional housing is registered in the lower rank housing. Information from the tenant corresponding to the first section of the upper rank three sectional housing is passed to lower rank housing and the result of an operation of that lower rank housing comprises information of a tenant corresponding to the second section of the upper rank three sectional housing. This link table can also nest another lower rank housing or link table. When a link table is nested as a tenant of the third section and a different lower rank three sectional housing is nested as a tenant of the corresponding second section, information from the link table is passed to a tenant of the first section of that lower rank three sectional housing that is not in the second section (pre-determination tenant).

It is preferable that information identifying each tenant coordinated to the housing structure and the arrangement thereof can be displayed on screen as a rooming table, that each tenant can be registered or the contents thereof can be edited by a user operating in the rooming table displayed on screen, and that for a lower rank housing, a different rooming table is displayed on screen for each concerning tenant specified by the user allowing the user to register a tenant or edit the contents of a tenant in that lower rank housing.

The above described methods can be implemented by a computer program.

According to a second aspect of this invention, it is provided an operation processing device which comprises an operation means for treating a three sectional housing as one processing unit in which the three sectional housing is structured by comprising a first section in which each kind of group of input elements for the phenomena to be made into a model is arrayed as a tenant in one line or one column, a second section in which an output elements group having a causal relationship with each individual tenant arranged in the first section is arrayed as a tenant in 1 column or 1 line and a third section in which logic revealing the respective relationships of each tenant arrayed in the first section and each tenant arrayed in the second section is arrayed as a tenant on a grid, such that, where a tenant exists that is common to both the first section and the second section, an output elements group obtained by a tenant of the second section is taken as an input elements group of a tenant that is common with the first section, and lower rank housings can be nested hierarchically to provide tenants for each section of the three sectional housing, wherein;

the operation means includes;

means that, when there is a lower rank housing forming a tenant in the first section and the second section of an upper rank three sectional housing commonly, operates in accordance with the operation sequence of the upper rank three sectional housing to pass information to the lower rank housing being a tenant of that second section and continues the operation of the upper rank three sectional housing using the result of the operation of the lower rank housing as information of the concerning tenant of the first section of the upper rank three sectional housing;

means that, when there is a lower rank housing forming a tenant only in the first section of the upper rank three sectional housing, operates to perform an operation for a lower rank housing prior to commencement of an operation for the concerning tenant for that upper rank three sectional housing and to continue the operation of that upper rank three sectional housing using the results of that lower rank housing operation as the information on the concerning tenant of the upper rank three sectional housing; and

means that, when there is a lower rank housing forming a tenant only in the second section of the upper rank three sectional housing, operates in accordance with the operation sequence of the upper rank three sectional housing to pass information to the lower rank housing forming the tenant of that second section, and to take the result of the operation of that lower rank housing as information of the concerning tenant of the upper rank three sectional housing.

According to this invention, lower rank housings are classified according to which section of the upper rank housing the lower rank housing is nested and processes are performed coordinated to those respective classifications. Thus, there is no need to unfold the nested housing in the rooming table of the upper rank housing for passing information with the upper rank housing and lower rank housing processes can taken as closed from upper rank housing processes. Accordingly, the structure of the rooming tables and housing becomes simple, and registration operations are easy to understand and can be performed simply. Further, according to this invention, not only three sectional housings, but also single sectional housings involving no operation can be handled in the same way as nested housings.

### BRIEF DESCRIPTION OF THE DRAWINGS

Specific embodiments of the present invention will now be described, by way of example only, with reference to the accompanying drawings in which:

FIG. 1 shows a configuration example of a three sectional housing used in the present invention;

FIG. 2 shows a configuration example of a single sectional housing used in the present invention;

FIG. 3 shows a rooming table corresponding to the housing shown in FIG. 1;

FIG. 4 shows a rooming table corresponding to the housing shown FIG. 2;.

FIG. 5 shows an example of a conventional rooming table where a lower rank three sectional housing is nested in an upper rank three sectional housing;

FIG. 6 shows an example of a rooming table where a lower rank three sectional housing is nested in an upper rank three sectional housing;

FIG. 7 shows an example of a rooming table where a lower rank single sectional housing is nested in an upper rank three sectional housing;

FIG. 8 is a flow chart showing the flow of processes when an operation is executed;

FIG. 9 shows an example of a combination of an upper rank housing and a lower rank nested housing;

FIG. 10 shows the flow of processes to generate and modify a model when intermediate determination housing is nested in an upper rank three sectional housing;

FIG. 11 shows the flow of processes when a nested housing operation is executed in accordance with execution of an operation of the upper rank three sectional housing;

FIG. 12 shows a three layer configuration of nested housings according to a conventional operation method;

FIG. 13 shows a three layer configuration of nested housings according to the present invention; and

FIG. 14 shows an example of a layered configuration for passing information in a midsection of a housing having a nested housing as a tenant.

### DETAILED DESCRIPTION OF THE PREFERRED EMBODIMENTS

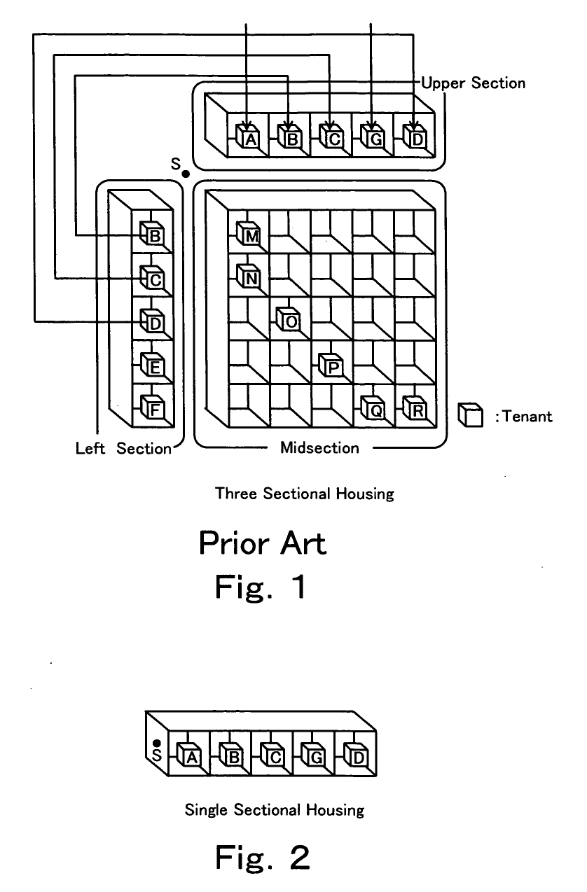

FIGS. 1 and 2 show a configuration of a three sectional housing and a single sectional housing respectively as examples of housings used in the present invention. Three sectional housing is formed of a first section in which each kind of group of input elements for the phenomena to be made into a model is arrayed as a tenant in one line or one column, a second section in which an output elements groups having a causal relationship with each individual tenant arranged in the first section is arrayed as a tenant in 1 column or 1 line and a third section in which logic revealing the respective relationships of each tenant arrayed in the first section and each tenant arrayed in the second section is arrayed as a tenant on a grid, in a configuration such that where a tenant exists that is common to both the first section and the second section, an output elements group obtained by a tenant of the second section forms an input elements group of a tenant that is common with the first section.

FIG. 1 shows an example in which the first section is arranged in the upper section, the second section is arranged in the left section and the third section is arranged in the midsection. Each section is constructed of rooms arrayed in grid formation and a tenant is housed in each of these rooms. For these tenants a different three sectional housing can be nested in layers.

In the example shown in FIG. 1 tenants A, B, C, G and D are housed in the upper section, and tenants B, C, D, E and F are housed in the left section. In the midsection in the column corresponding to tenant A of the upper section and the line corresponding to tenant B of the left section is accommodated tenant M which shows the relationship of tenants A and B. Thereunder, in the same manner, tenant N is housed in the line of tenant C in the column of tenant A, tenant O is housed in the line of tenant D in the column of tenant B, tenant P is housed in the line of tenant E in the column of tenant C, tenant Q is housed in the line of tenant F in the column of tenant G and tenant R is housed in the line of tenant F in the column of tenant D. In this configuration, starting from starting point S at the left of the upper section, information of tenant A of the upper section is processed by the operation described in tenant M of the midsection and the result of this is put into tenant B of the left section. The information of tenant A processed by tenant M is further processed by the operation described in tenant N of the midsection and the result of this is put into tenant C of the left section. Information of tenant B of the left section becomes information of tenant B of the upper section as it is and the latter is processed by the operation of tenant O of the midsection, the result thereof is put into tenant D of the left section. In the same manner, each of the outputs for tenants of the left section are obtained in respect of the input for tenants A and G of the upper section. Illustrated as an expression, the operation sequence is

B=M*A

C=N*A

D=O*B

E=P*C

F=(Q*G)\hat{ }(R*D)

Where * represents a vertically directed operation (e.g. inner product) and \hat{ } represents a horizontally directed operation (e.g. addition).

In addition to a three sectional housing, the present invention introduces a single sectional housing that maintains the same relationship as the relationship of an upper rank housing and a nested housing. Such a single sectional housing is to perform no processing but simply passing information unless a three sectional housing accompanying some operations is nested in the single sectional housing and is arrayed horizontally if arranged in the upper section and longitudinally if arrayed in the midsection. Accordingly, in respect of nest structures both single sectional housings and three sectional housings can be handled equivalently.

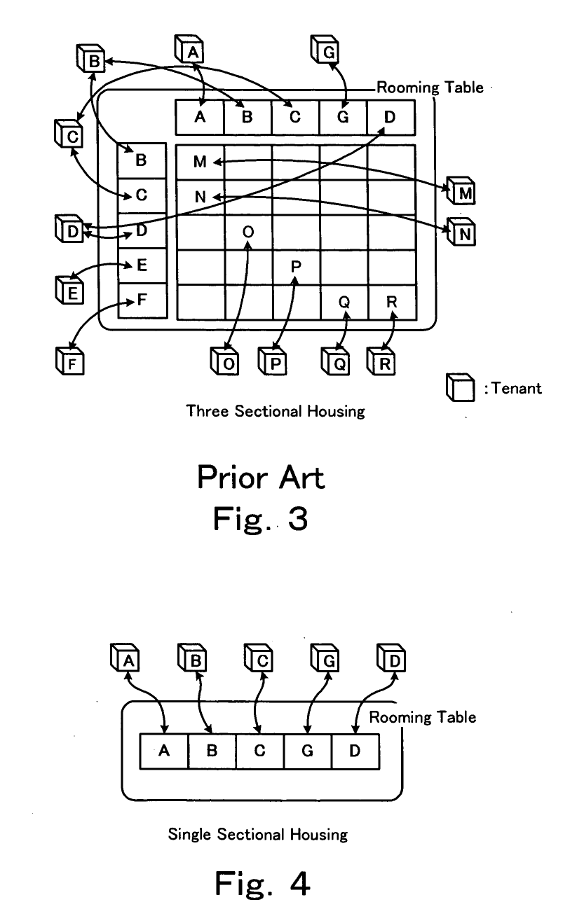

FIGS. 3 and 4 show the respective rooming tables corresponding to the housings shown in FIG. 1 and FIG. 2. These rooming tables enable display and arrangement on screen of information identifying each tenant coordinated to the housing structure, and enable a user operating in the rooming table displayed to register a tenant or edit the contents of a tenant. Information identifying a tenant housed in the upper section or the left section can include the name of the tenant and for a tenant of the midsection, a type symbol identifying characteristics of the operation can be used.

The nest structure disclosed in the above described prior application will now be described before commencing a description of the embodiments of this invention.

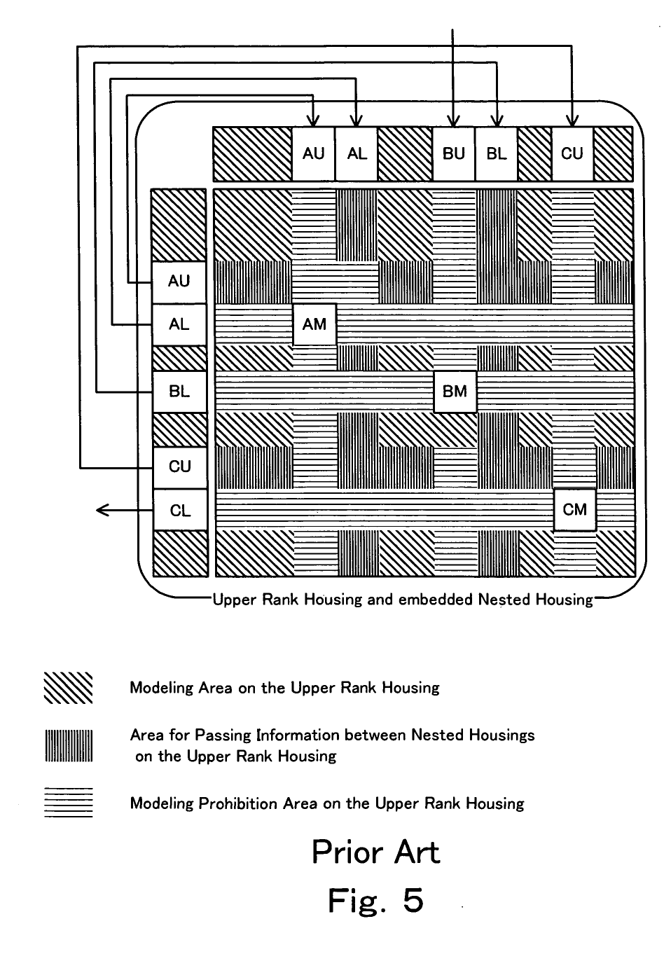

FIG. 5 shows an example of a conventional rooming table where a lower rank three sectional housing is nested in an upper rank three sectional housing. In this example, nested housing A provides an example of an intermediate determination housing that receives information obtained during an operation for the upper rank three sectional housing, performs an operation on the information and passes the information to the upper rank three sectional housing. Nested housing B provides an example of a predetermination housing that computes information having no causal relationship with an operation for the upper rank three sectional housing and passes that information to the upper rank three sectional housing and nested housing C provides an example of a post-determination housing that performs an operation for the result of the upper rank three sectional housing operation.

For nested housing A, upper section AU and left section AL thereof are registered in the respective upper section and left section rooms of the upper rank three sectional housing while a crossover type registration is performed, registering left section AL in an upper section room of the upper rank three sectional housing and registering upper section AU in a left section room. Further, in the midsection of the upper rank three sectional housing are registered a tenant of an operation for passing information from the upper rank three sectional housing to the upper section of the nested housing A, a tenant of midsection AM of nested housing A and a tenant of an operation to pass information from the left section of nested housing A to the upper rank three sectional housing.

Nested housing B is a pre-determination housing, upper section BU and left section BL thereof being registered in the respective upper section and left section rooms of the upper rank three sectional housing while left section BL is registered in an upper section room of the upper rank three sectional housing. Further, in the midsection of the upper rank three sectional housing are registered a tenant of midsection MB of nested housing B and a tenant of an operation to pass information from left section BL of nested housing B to the upper rank three sectional housing.

Nested housing C is a housing for performing an operation of the result of an operation for the upper rank three sectional housing, upper section CU and left section CL thereof being registered in the respective upper section and left section rooms of the upper rank three sectional housing while upper section CU is registered in an upper section room of the upper rank three sectional housing. Further, in the midsection of upper rank three sectional housing are registered a tenant of an operation for passing information from the upper rank three sectional housing to the upper section of the nested housing C and a tenant of midsection CM of nested housing C.

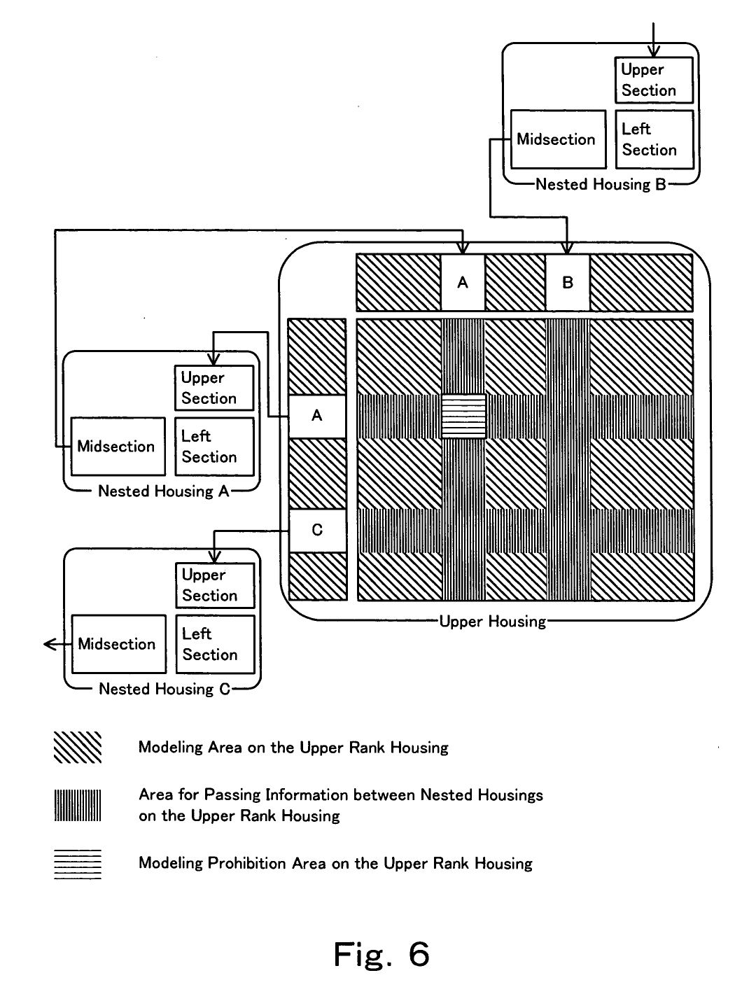

FIG. 6 shows an example of a rooming table where lower rank three sectional housings are nested in an upper rank three sectional housing. Here, in the same manner as the description for the conventional example shown in FIG. 5, the description will proceed using as examples intermediate determination, pre-determination and post-determination nested housings A, B and C.

For executing an operation of the housing, an operator should register or edit data in the rooming table. That is to say, tenant names are registered in the upper section and left section of the rooming table of the upper rank three sectional housing (hereinafter called as an “upper rank rooming table”), while type symbols identifying characteristics of operations are registered in the midsection. Individual tenants are selected and their contents generated or edited. For housings that will be nested, only there names are registered. It is not necessary to specify the section names of the nested housings in the upper rank rooming table. It is not required to register nested housings in the midsection of the upper rank rooming table and to acquire areas for intermediate tenants in the midsection so that redundant expressions are avoided. If it is required for the benefit of a user, such a conventional redundant expression can be selected for display. When a nested housing name is selected from a screen display of the upper rank rooming table, the nested housing mode is used in which another rooming table is displayed for that nested housing enabling in a series of screens for performance of ordinary nested housing creation, registration and display operations.

Once the registration in the rooming table and contents editing operations are complete, a check is performed to confirm that there are no rule infringement related problems in the registered contents and if there are no such problems the actual operation is performed. As nested housing A forms a tenant common to both the upper or first section of the upper rank sectional housing and the left or second section, for nested housing A the processes of the operation involve passing information to nested housing A forming a tenant of that left section in accordance with the operation sequence of the upper rank three sectional housing, and continuing an operation for that upper rank three sectional housing using the result of the operation of that nested housing A as information of the concerning tenant of the upper section of the upper rank three sectional housing. For nested housing B, this forms a tenant only of the upper section of the upper rank three sectional housing, so prior to commencing an operation of a concerning tenant for that upper rank three sectional housing an operation for nested housing B is performed and an operation for that upper rank three sectional housing continues using the result of the operation for nested housing B as information of the concerning tenant of the upper rank three sectional housing. For nested housing C, this forms a tenant only of the left section of upper rank three sectional housing, so information is passed to nested housing C in accordance with the operation sequence of the upper rank three sectional housing and the operation result of nested housing C constitutes information of the concerning tenant of the upper rank three sectional housing.

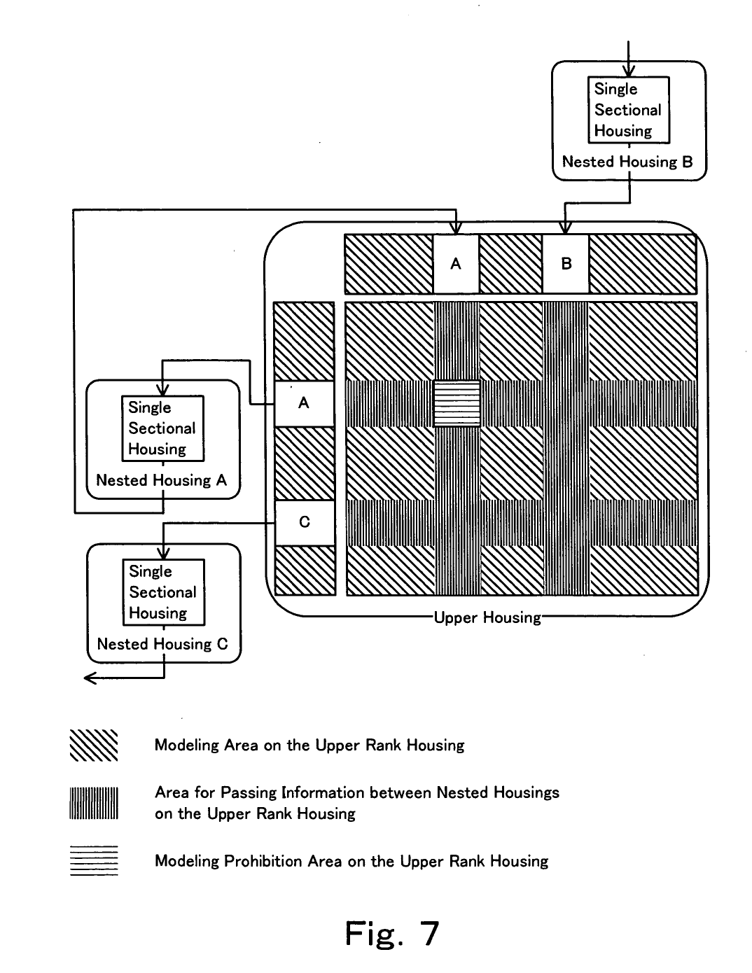

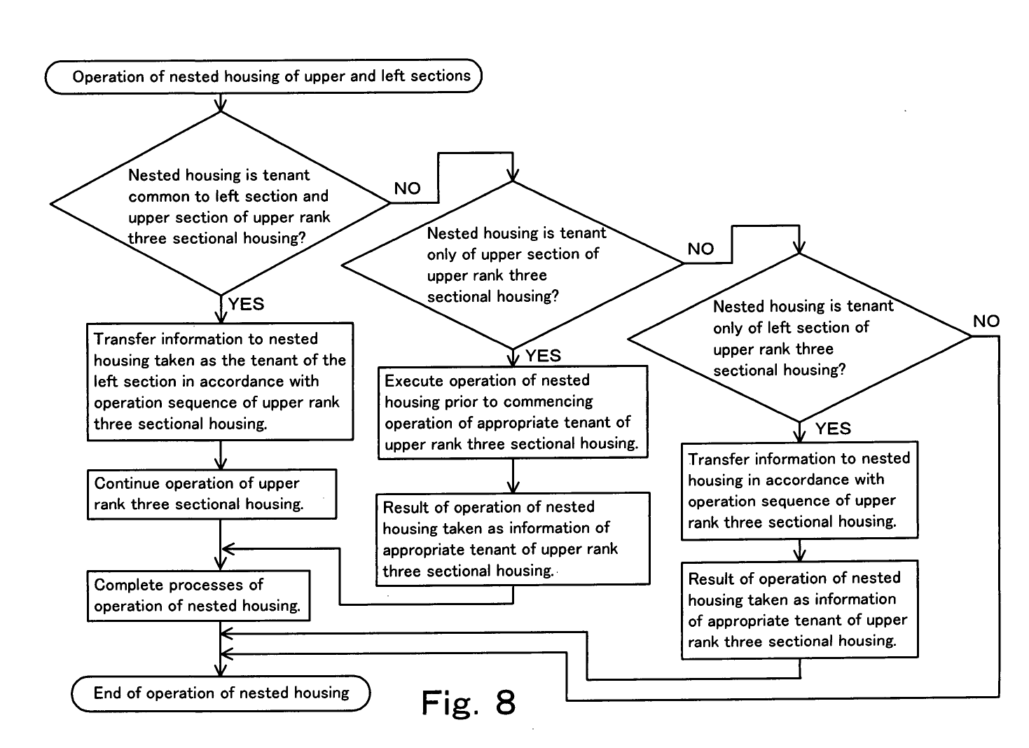

FIG. 7 shows an example of a rooming table where a lower rank single sectional housing is nested in an upper rank three sectional housing. Here, in the same manner as the description provided in respect of FIG. 6, the description proceeds using as examples intermediate determination, pre-determination and post-determination nested housings A, B and C. For an intermediate determination nested single sectional housing, as shown by nested housing A in FIG. 7, information from the upper rank three sectional housing is received at the left section of the upper rank three sectional housing, the information as it is, passed to the single sectional housing of the same name as the upper section of the three sectional housing before returning to the operational sequence of the upper sectional housing. For pre-determination nested single sectional housing, as shown by nested housing B in FIG. 7, it is only registered in the upper section of the upper rank three sectional housing. In the execution of the operation of the upper rank three sectional housing, nested housing B itself being predetermined, information is passed from tenants of the internal structure of that nested housing B to the upper rank housing and the processing follows the operation sequence of the upper rank housing. In the same manner, in the case of a post-determination nested single sectional housing, as shown by nested housing C in FIG. 7, this only exists in the left section of the upper rank three sectional housing, and in the execution of the operation for the upper rank three sectional housing, this post-determination housing itself being post determined, information from the upper sectional housing is passed and stored in tenants of the internal structure of that post-determination nesting.

FIG. 8 shows the flow of processes when an operation as described with reference to FIGS. 6 and 7 is executed.

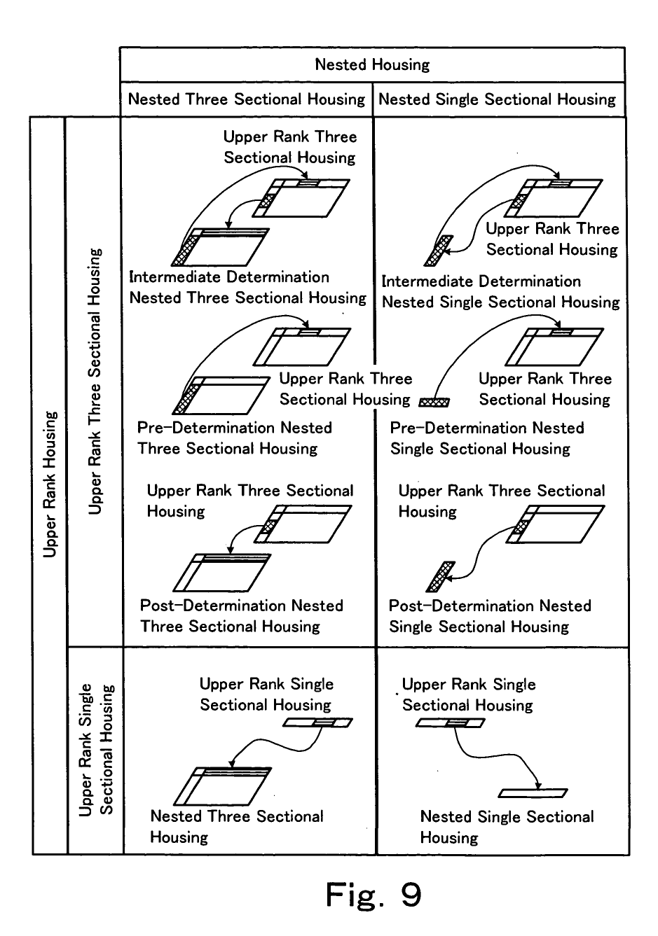

FIG. 9 shows an example of a combination of an upper rank housing and a lower rank nested housing. In the description provided above, the upper rank housing is a three sectional housing and the description proceeds showing the case where lower rank three sectional housings or single sectional housings are nested therein, however three sectional housings or single sectional housings can also be nested in a single sectional housing.

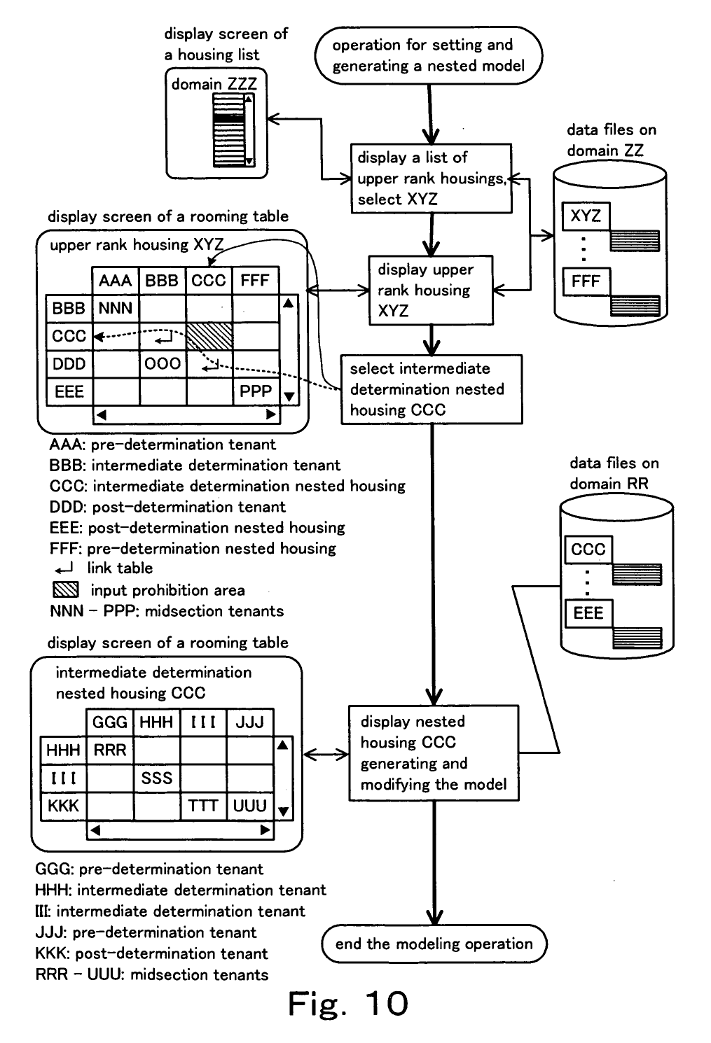

FIG. 10 shows the flow of processes to generate and modify a model when intermediate determination housing is nested in an upper rank three sectional housing. For this description, all housings are three sectional housings and therefore the words “three sectional” are omitted.

An operator of housing domain ZZ selects an upper rank housing XYZ from a housing list, wherein housing XYZ brings nested housings, one each of intermediate determination nested housing, pre-determination nested housing and post-determination nested housing, so that an upper rank rooming table is displayed. Then the operator selects intermediate determination nested housing CCC, enters a remote domain RR different from the domain of the operator and performs model generating and modifying operations on screen on the display of housing CCC managed in that domain.

Because for the upper rank rooming table, an intermediate tenant must be registered in both the upper and left sections, intermediate determination nested housing CCC is also registered its name in both the upper and left sections. In the midsection, the location of the intersection corresponding to the intersection of this registered name forms an operating loop and therefore input is prohibited so input operations cannot be received. As a result of these registration and modification operations in the rooming table, the subsequent operation sequence setting can be read from the screen displayed. The result of an operation of upper section tenant AAA and midsection tenant NNN is passed into intermediate tenant BBB. Via the link table indicated by the leftward curving arrow, data from tenant BBB is passed to upper section pre-determination tenants of housing CCC. The operation of housing CCC is performed and the resulting tenants of the left section of housing CCC is passed to the upper section tenant named CCC of the rooming table.

Data passes via the link tables from CCC indicated by the leftward curving arrow, the result of the operations as determined by tenant BBB and midsection tenant OOO, and the result of operations performed along the horizontal direction are passed to post-determination tenant DDD.

The upper section tenant resulting from the operation of pre-determination nested housing FFF is subjected by an operation of tenant PPP, and the result of the operation is passed to post-determination nested housing EEE in the upper section, where the operation of EEE is performed.

The operator, envisaging such operations, commences an operation to generate or modify a model of this intermediate determination nested housing CCC by clicking on CCC of the left section or the upper section to open the rooming table having the nest, wherein, because this is an intermediate determination nest, the same rooming table is displayed no matter which CCC is clicked, and commences the model generation or modification operations. Further, when necessary, the operator can proceed to unfold a tenant and perform a required modification operation on the data. In the same manner, a registration or modification operation of a pre-determination nested tenant or post-determination nested tenant is performed by unfolding the information from the upper rank housing to the lower rank housing. To set the changes, the operator returns to the upper rank housing screen and finishes.

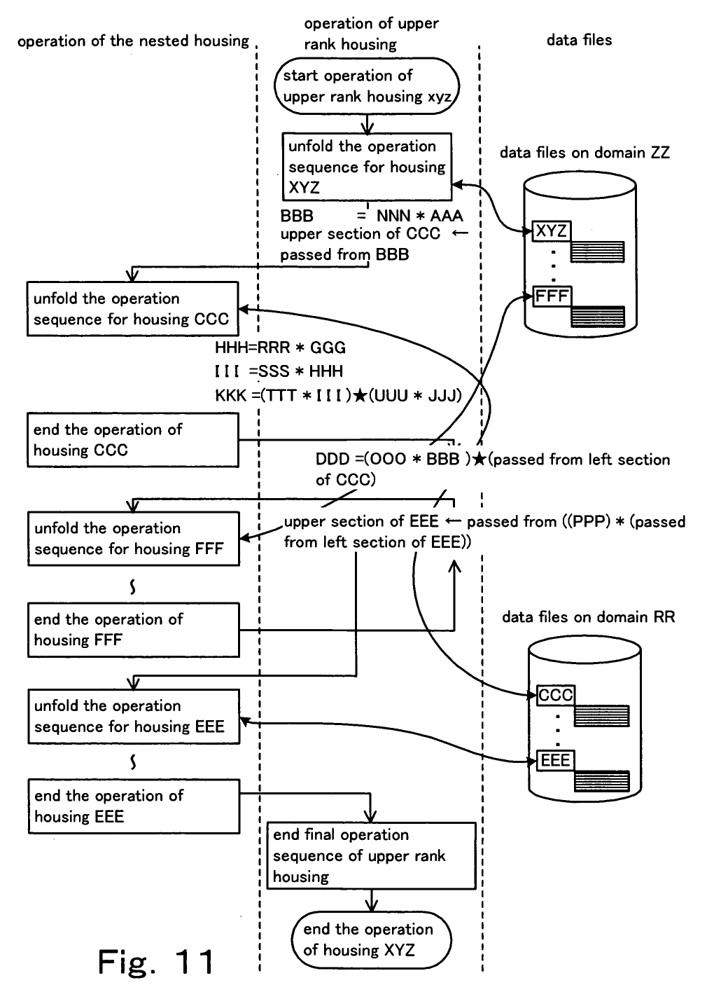

FIG. 11 shows the flow of processes when a nested housing operation is executed in accordance with execution of an operation of an upper rank three sectional housing. To perform an operation of upper rank housing XYZ having nested housings already registered, the upper rank housing rooming table is called up internally at the execution phase, and each step is executed in accordance with the unfolded operation sequence. As a nested housing is encountered, the nested housing is called up and the operation sequence is unfolded and executed. At the point when all of those steps have been executed, the process returns to execute the sequence of the upper rank housing, then runs and completes the operation.

For this embodiment, at the point in time when pre-determination nested housing FFF is encountered in the sequence of upper rank housing XYZ operation execution, the operation of that nested housing is run and the resulting data of the left section tenants are passed to the upper rank housing. The operation of the upper rank housing is then performed using the data as the pre-determination.

In this example of an executed operation, at the point in time when post-determination nested housing EEE is encountered, data is passes to the pre-determination tenant of the upper section of that post-determination nested housing, and the concerning operation is run through to completion before returning to the upper rank housing. As no subsequent operation steps remain, execution of the operation of upper rank housing XYZ is completed.

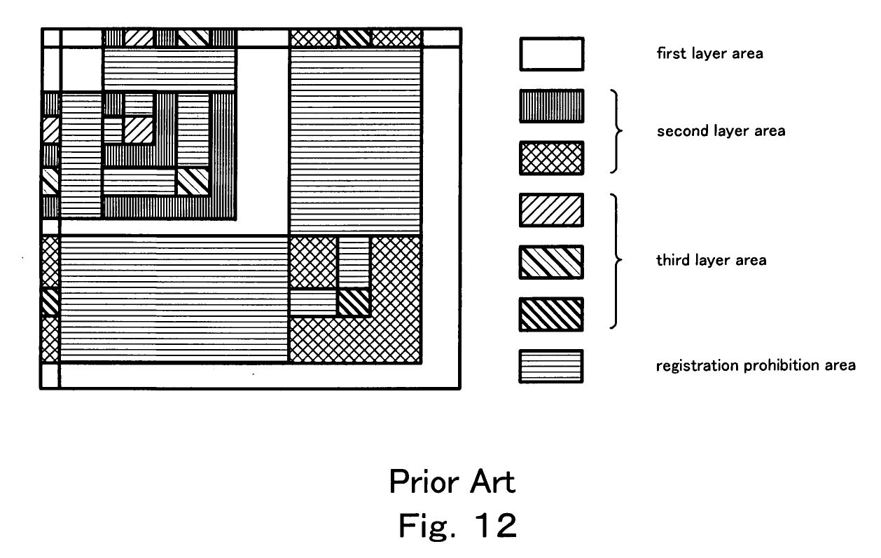

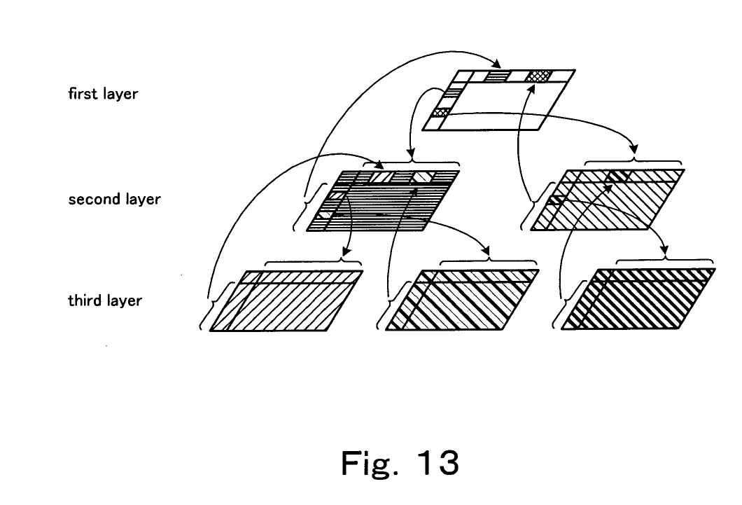

FIG. 12 shows a three layer configuration of a nested housing according to a conventional operation method and FIG. 13 shows a three layer configuration of a nested housing according to the present invention. According to prior art technology, formation of a layered configuration required formation as shown in FIG. 12, however the present invention enables formation of a multi-layered configuration providing an image natural to an operator, as shown in FIG. 13. Thus, when layering other housings as nests in the upper or left sections of a three sectional housing, the following effects are realized:

1. The rooming table of the upper rank housing having nested housings can be made substantially more compact both vertically and horizontally, broadening the displayed area of a model and substantially reducing the amount of scrolling required;

2. Registration operations to the rooming table of the high rank housing are concise, and considerably less laborious as, in the case of an intermediate determination nested housing, registration locations are reduced from 5 locations to 2 and in the case of a pre-determination or post-determination nested housing, registration locations are reduced from 4 locations to 1;

3. Sectional divisions need not be applied for a registered name, making a registered name shorter and reducing the workload for a name registering setting operation, moreover, this avoids the confusion that arises in a cross matching arrangement of the section name of upper rank housing and the sectional division of nested housing registered therein;

4. Registration prohibition areas in the upper rank rooming table are reduced (for intermediate determination nested housing, meaningless areas occur in the midsection however these can be eliminated from the system side), thereby avoiding the possibility of creating confusion for an operator.

Further, due to the design of a single sectional housing the registration of the nested housing itself is brief, and as no operation is run, this realizes improved efficiency. Moreover, the upper section and the left section of a three sectional housing can be configured by multi-layered nesting configuration of single sectional housings only. The above description demonstrates nested configurations of housings in the upper section and the left section of a three sectional housing however the same layered configuration can be achieved for a midsection tenant also.

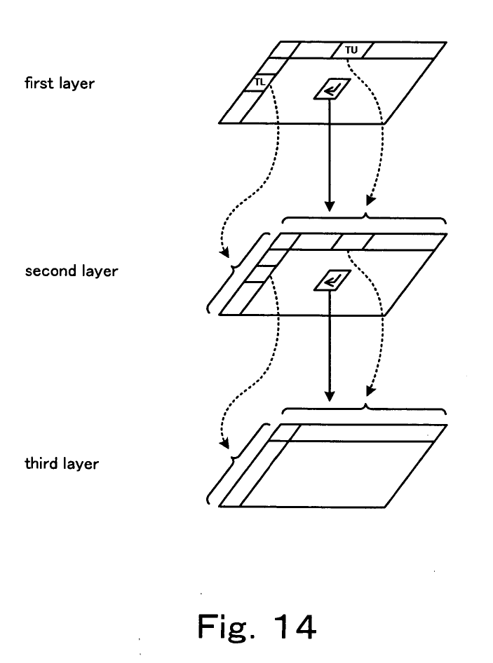

FIG. 14 shows an example of a layered configuration for passing information in a midsection of a housing having a nested housing as a tenant. Here, a lower rank housing can be nested as a midsection tenant of an upper rank three sectional housing and a link is registered in that lower rank housing for passing information between information of tenant TU corresponding to the upper section of the upper rank three sectional housing and tenant TL corresponding to the left section. Information from tenant TU is then passed to the link table and the result of the operation of that link table forms information of tenant TL.

Here, when a three sectional housing is nested in tenant TU, information of the left section of that three sectional housing nested is passes to the upper section of the link table. When a three sectional housing is nested in tenant TL, the information obtained in the left part of the link table is passed to a pre-determined tenant among tenants of the upper section of the three sectional housing nested in tenant TL.

As shown in FIG. 14, even the nested link table can accommodate further nested structures. In this way, in the same manner as applies for the upper section and the left section, a multi-layered configuration providing an image natural to an operator can be formed, and a compact rooming table allowing a broadened displayed area of a model with substantially reduced scrolling can be realized.

What is claimed is:

1. An operation processing method for treating a three sectional housing as one processing unit, wherein;
the three sectional housing is structured by comprising a first section in which each kind of group of input elements for the phenomena to be made into a model is arrayed as a tenant in one line or one column, a second section in which an output elements group having a causal relationship with each individual tenant arranged in said first section is arrayed as a tenant in 1 column or 1 line and a third section in which logic revealing the respective relationships of each tenant arrayed in said first section and each tenant arrayed in said second section is arrayed as a tenant on a grid, such that, where a tenant exists that is common to both said first section and said second section, an output elements group obtained by a tenant of said second section is taken as an input elements group of a tenant that is common with said first section, and one or more lower rank housings can be nested hierarchically to provide tenants for each section of the three sectional housing;
when there is a lower rank housing forming tenants in the first section and the second section of an upper rank three sectional housing commonly, in accordance with the operation sequence of that upper rank three sectional housing information is passed to the lower rank housing being the tenant of that second section, and the operation of that upper rank three sectional housing continues using the result of the operation of the lower rank housing as information of the concerning tenant of the first section of the upper rank three sectional housing;
when there is a lower rank housing forming a tenant only in the first section of the upper rank three sectional housing, prior to commencement of an operation for the concerning tenant for that upper rank three sectional housing, a lower rank housing operation is performed and using the results of that lower rank housing operation as the information on the concerning tenant of the upper rank three sectional housing, the operation for that upper rank three sectional housing continues;
and when there is a lower rank housing forming a tenant only in the second section of the upper rank three sectional housing in accordance with the operation sequence of the upper rank three sectional housing information is passed to the lower rank housing forming the tenant of that second section, and the result of the operation performed of that lower rank housing is taken as information of the concerning tenant of the upper rank three sectional housing.

2. The operation processing method according to claim 1 wherein the lower ranking housing is itself one three sectional housing, information from the upper rank three sectional housing is taken as information of the first section, and information obtained in the second section can be passed to the upper rank three sectional housing.

3. The operation processing method according to claim 1 wherein the lower rank housing is single sectional housing for which input and output element groups are arranged respectively as tenants in one line or one column but where these themselves do not require execution of an operation.

4. The operation processing method according to claim 3 wherein said single sectional housing can nest a further different single sectional housing or three sectional housing as a tenant.

5. The operation processing method according to claim 1 wherein when a lower rank housing is nested as a tenant of the third section of the upper rank three sectional housing, a table for passing information between a tenant corresponding to the first section of that upper rank three sectional housing and a tenant corresponding to the second section of that upper rank three sectional housing is registered in said lower rank housing, information from the tenant corresponding to the first section of the upper rank three sectional housing is passed to the lower rank housing and the result of an operation of the lower rank housing is taken as information of a tenant corresponding to the second section of the upper rank three sectional housing.

6. The operation processing method according to claim 5 wherein when a different lower rank three sectional housing is nested as a tenant corresponding to said second section, information is passed to a tenant of the first section but not of the second section of the lower rank three sectional housing.

7. The operation processing method according to claim 1 wherein
information identifying each tenant coordinated to the housing structure and the arrangement thereof can be displayed on screen as a rooming table, each tenant can be registered or the contents thereof can be edited by a user operating in said rooming table displayed on screen, and
for a lower rank housing, a different rooming table can be displayed on screen for each concerning tenant specified by the user allowing the user to register a tenant or edit the contents of a tenant in the lower rank housing.

8. A program for executing in a computer any of the methods according to claim 1 through claim 6.

9. An operation processing device which comprises an operation means for treating a three sectional housing as one processing unit in which the three sectional housing is structured by comprising a first section in which each kind of group of input elements for the phenomena to be made into a model is arrayed as a tenant in one line or one column, a second section in which an output elements group having a causal relationship with each individual tenant arranged in said first section is arrayed as a tenant in 1 column or 1 line and a third section in which logic revealing the respective relationships of each tenant arrayed in said first section and each tenant arrayed in said second section is arrayed as a tenant on a grid, such that, where a tenant exists that is common to both said first section and said second section, an output elements group obtained by a tenant of said second section is taken as an input elements group of a tenant that is common with said first section, and lower rank housings can be nested hierarchically to provide tenants for each section of the three sectional housing, wherein;
the operation means includes;
means that, when there is a lower rank housing forming a tenant in the first section and the second section of an upper rank three sectional housing commonly, operates in accordance with the operation sequence of the upper rank three sectional housing to pass information to the lower rank housing being a tenant of that second section and continues the operation of the upper rank three sectional housing using the result of the operation of the lower rank housing as information of the concerning tenant of the first section of the upper rank three sectional housing;
means that, when there is a lower rank housing forming a tenant only in the first section of the upper rank three sectional housing, operates to perform an operation for a lower rank housing prior to commencement of an operation for the concerning tenant for that upper rank three sectional housing and to continue the operation of that upper rank three sectional housing using the results of that lower rank housing operation as the information on the concerning tenant of the upper rank three sectional housing; and
means that, when there is a lower rank housing forming a tenant only in the second section of the upper rank three sectional housing, operates in accordance with the operation sequence of the upper rank three sectional housing to pass information to the lower rank housing forming the tenant of that second section, and to take the result of the operation of that lower rank housing as information of the concerning tenant of the upper rank three sectional housing.
